(19) United States
(12) Patent Application Publication
(10) Pub. No.: US 2022/0060877 A1
(43) Pub. Date: Feb. 24, 2022

(54) EMERGENCY GPS SIGNAL SYSTEM

(71) Applicant: Cade Robertson, Washington, UT (US)

(72) Inventor: Cade Robertson, Washington, UT (US)

(21) Appl. No.: 17/399,351

(22) Filed: Aug. 11, 2021

Related U.S. Application Data
(60) Provisional application No. 63/067,730, filed on Aug. 19, 2020.

(51) Int. Cl. H04W 4/90; H04W 4/14; G08B 27/00; H04W 4/02

(52) U.S. Cl. CPC H04W 4/90; H04W 4/02; G08B 27/001; H04W 4/14

(57) ABSTRACT

An emergency GPS signal system includes a user transmitting an emergency distress signal from an internet-connected device. The emergency distress signal has information concerning the emergency, as inputted or selected by the user, along with location information. The location information may be obtained via GPS, wireless signals, or may be preprogrammed. Utilizing the emergency GPS signal system allows a user a discreet (e.g., inaudible) approach to notifying emergency responders of an emergency situation and its specific location.

### CROSS-REFERENCE TO RELATED APPLICATIONS

This application claims the benefit of U.S. Provisional Patent Application Ser. No. 63/067,730 filed on Aug. 19, 2020, which is incorporated herein by reference.

### TECHNICAL FIELD

The present disclosure relates to signaling devices and emergency notifications. More particularly, the present disclosure relates to a software application that, when activated, initiates an emergency signal with location information and the nature of the emergency.

### BACKGROUND

Emergencies are a common fact of life that affect every human being. Some of these emergencies may occur in private or public settings, such as at school, home, or work. For example, school shootings happen without any forewarning and, often, the means to contact emergency units are inadequate. In particular, when a school shooting occurs, some teachers are required to have students hide in a corner and slide a colored paper under the door revealing how many people are in the classroom. While this approach is designed to notify emergency responders of the people inside the classroom, it may also result in unwanted consequences. Not only would emergency responders know if there are people in a classroom and the number of people, but the active shooter would be notified of the presence of people inside each classroom as well. Aside from previously mentioned protocols, such as the paper under the door, it is difficult for emergency responders to know the situation in each classroom. Specifically, an emergency responder would not know the classrooms where people are located, how many people are in each room, or whether there are any injured people. Emergency responders may also not be familiar with the building layout, making it difficult for them to locate emergency situations in a timely manner.

Other emergency situations may involve home invasion or domestic violence. Similar to the situation presented above, it may be difficult for an individual (e.g., victim) to notify emergency responders of an abuser or an intruder without compromising their location or intentions to the invader/abuser. For example, an abuse victim who is continually abused may not know how to contact an emergency responder secretly, or the abuse victim may try to call 911, but will create a story (e.g., ordering a pizza) in the hopes that the abuser will not be alerted while, hopefully, the responder will understand the intent of the phone call. There are countless scenarios where it may be ideal to contact emergency responders without an audible request. Further, individuals that are hearing impaired may have difficulty contacting emergency responders and relaying the emergency effectively.

There are several options on the market for contacting emergency responders; however, most options do not allow an individual to contact emergency services directly and secretively. In particular, almost all SOS applications are created to contact emergency contacts (e.g., family members) or are connected to smart home and home security. Further, SOS applications do not notify emergency responders of the individual's specific location. Thus, there is not an easy, convenient, and secretive (i.e., non-audible) way of notifying the emergency responders of emergency or abusive situations and of the exact location of those situations.

Accordingly, there is a need for an emergency application that silently notifies emergency responders and is accompanied with location information, such as a GPS location. The present disclosure seeks to solve these and other problems.

### SUMMARY OF EXAMPLE EMBODIMENTS

In one embodiment, an emergency GPS signal system comprises an internet-connected device having a user interface configured to allow a user to input a description of an emergency and to request services. In some embodiments, the user interface comprises pre-configured messages (e.g., “Active Shooter”) that a user may select. The user input is then transmitted, along with location information, to emergency responders (e.g., police, EMTs, Firemen, etc.). In one embodiment, the location of the sender is preconfigured, such as a certain classroom in a school. In another embodiment, the location of the user is determined using GPS, Wi-Fi, triangulation, or other known methods for locating a user device.

In one embodiment, a method of using the emergency GPS signal system comprises accessing a user interface for transmitting an emergency request. In one example, the user interface is a website. In one embodiment, the user interface is a smartphone application. The user interface prompts the user to answer certain questions and submit the form to emergency responders. For example, a user may access the user interface by launching a smartphone application. Upon launch, a user confirms, such as by pressing “Activate” or other operable terms, that they would like to activate an emergency distress signal. In some embodiments, a user may also, either prior to activating the signal, after activation, or simultaneously with submission, submit additional information. The additional information may include, but not be limited to, location information, number of victims, number of intruders/abusers, nature of the emergency (e.g., active shooter, heart attack, accident), or other information.

Emergency responders and others (e.g., administrators, other teachers in a school setting, family members, etc.) then receive the emergency distress signal and any accompanying information, including a map and location information. The map may show the interior layout of a building, such as a school, with the location of the user that initiated the signal. This allows responders to pinpoint exactly where an emergency is taking place within a building. In some embodiments, GPS or other location information may be obtained by the emergency responders.

In one embodiment, a method of receiving and responding to a distress signal comprises an emergency responder receiving a distress signal on a GPS emergency application. The responder then determines whether the GPS coordinates were received. If the GPS location is received, responders are sent to the location. If the GPS location is not received, the application requests the GPS signal location from the sending device.

In one embodiment, the GPS emergency application comprises an intermediate step that prevents toddlers from accessing or initiating an emergency response.

### BRIEF DESCRIPTION OF THE DRAWINGS

FIG. 1 illustrates a flowchart of a user using an emergency GPS signal system;

FIG. 2 illustrates a flowchart of a responder using an emergency GPS signal system;

FIG. 3 illustrates a user interface of an emergency GPS signal system;

FIG. 4 illustrates a user interface of an emergency GPS signal system;

FIG. 5 illustrates an emergency responder and administrative interface of an emergency GPS signal system;

FIG. 6 illustrates an emergency responder and administrative interface of an emergency GPS signal system;

FIG. 7 illustrates an emergency responder and administrative interface of an emergency GPS signal system; and

FIG. 8 illustrates an emergency responder and administrative interface of an emergency GPS signal system;

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need for an emergency application that silently notifies emergency services by sending out a distress signal coupled with location information. The present disclosure seeks to solve these and other problems.

Emergency software applications on the market allow an individual to send distress signals to their contacts, such as family members, friends, etc.; however, the applications found in the prior art fail to alert emergency responders (e.g., police, firemen, EMTs, etc.) of the situation and fail to notify the responders of the location of the individual. In contrast, the emergency GPS signal system described herein comprises location information which allows emergency responders to know the exact location of the user. For example, emergency responders will have the ability to know the location of everyone in a school building before entering, instead of having to enter situations blindly.

In some embodiments, by having the GPS application on each student's and faculty's phones, emergency responders can have GPS information in real time. Responders will know, for example, where the students are located, such as in the bathroom, closet, or outside at recess. Not only may the application be used at K-12 schools, but it may also be used at universities, hospitals, malls, and other public and private spaces. The GPS emergency application gives victims and emergency responders a tool to control emergency situations with real-time data. Further, emergency responders may make crucial decisions with the knowledge of the emergency, and, more importantly, the exact location of the emergency.

In one embodiment, an emergency GPS signal system comprises an internet-connected device and a GPS emergency application. The internet-connected device may be a smartphone, computer, tablet, or any other device capable of downloading the GPS emergency application or accessing a website. In some embodiments, the internet-connected device further comprises a GPS receiver. It will be appreciated that utilizing the GPS emergency application allows a user a discreet (i.e., inaudible) approach to notifying emergency responders of an emergency situation and an its specific location using the GPS location data.

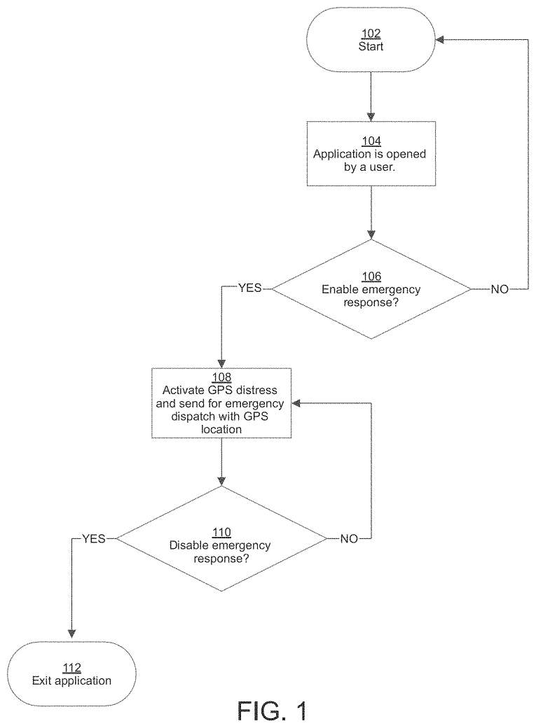

In one embodiment, as shown in FIG. 1, a method of using the emergency GPS signal system starts at 102. Then, at step 104, a user opens a GPS emergency application on an internet-connected device (e.g., smartphone) by selecting the icon. At 106, the user is then asked whether to enable an emergency response. The emergency response is activated by selecting a “yes” command on the GPS emergency application. An emergency distress signal (e.g., message) is then transmitted to emergency responders. This may be accomplished using methods known in the art, including messaging servers, cloud-computing systems, etc. In one embodiment, the application may also present a user with several types of pre-selected emergency messages to transmit, such as an “Active Shooter” or “Fire,” or may also allow a user to type a customized message to be sent to emergency responders. Once the distress signal/message has been sent, at step 106, the emergency responders are notified (either directly, such as by using push notifications, or through a dispatcher who may transmit information to relevant responders) of the emergency and given the exact GPS location of the user and the user is notified that emergency responders are on their way. For example, at step 106, when a user enables the emergency response, the software transmits the GPS location from the GPS receiver to the emergency responders, allowing the responders to know the exact location of the user. The user may also select a “no” or “cancel” command, which takes the user out of the application and fails to send the notification to emergency responders.

Once the emergency distress signal is enabled, a prompt to terminate the signal, such as a “Stop” or “Cancel” button on the screen, remains on the screen. After the emergency situation is resolved, the user may disable the prompt at 110 by selecting the “Stop” or “Cancel” button. The application may then be exited at step 112. Referring back to step 110, if the “Stop” or “Cancel” button is accidently tapped during the emergency, a second prompt confirms that the user intended to cancel. If not, the user can tap NO to continue to have the emergency distress signal transmitted.

In one embodiment, a user may also be connected to real-time chat with emergency responders, allowing emergency responders and personnel to discuss the emergency in writing, rather than audibly. This may be accomplished using chat servers or other known methods for text messaging/chatting known in that art (examples of chat systems in the art include cellular text messages, internet-based messaging systems such as WhatsApp, or other messaging platforms). For example, after the distress signal is activated in step 108, a user may be presented with a real-time chat box for chatting with one or more responders. This allows the user and responders to communicate, silently, in real-time.

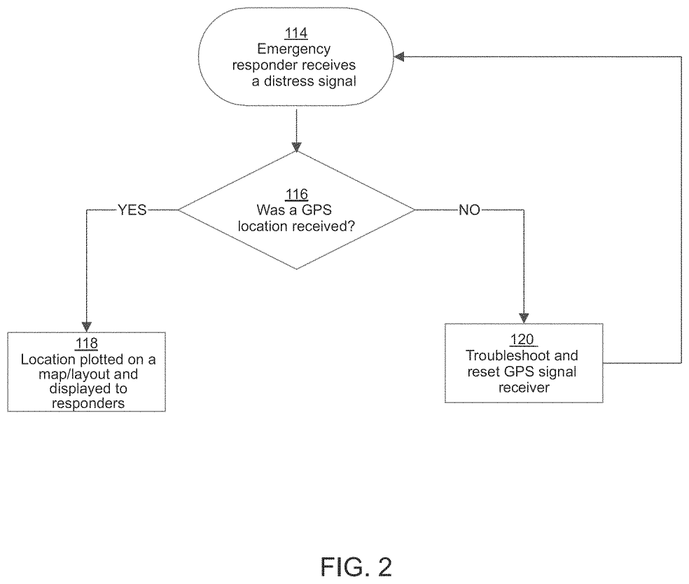

In one embodiment, as shown in FIG. 2, a method of receiving and responding to an emergency distress signal comprises, at step 114, an emergency responder receiving an emergency distress signal. At step 116, a software application determines, using a processor and logic, whether a GPS location for the distress signal was received. If the GPS location was received, then, at step 118, responders are sent to the emergency location. If the GPS location is not received, then, at step 120, the software application sends a signal to the user device to request the GPS coordinates, which the user device may then acquire using its GPS receiver and then transmit to the responder's device. It will be appreciated that by using location information, responders can quickly gather the location of the emergency and quickly respond. While GPS is used as an example herein, other methods may also be used, either alone or in combination, such as triangulation, trilateration, wireless signals (e.g., Wi-Fi signals, IP address, etc.), predetermined and preprogrammed location information, etc.

In one embodiment, both the emergency dispatch center and the responders receive location information, in real time, of the user sending the emergency distress signal. It will be appreciated that multiple distress signals may be received, with their accompanying location information plotted on a geographic map or structure layout interface. For example, in the event of a school shooting where multiple distress signals are transmitted by a plurality of users and each signal is received by responders, the emergency responders may view a screen (e.g., smartphone screen, tablet screen, computer screen, etc.) that plots the location of each emergency distress signal on the same map or layout, allowing the responders to quickly find and secure victims and potential victims, or to locate the intruder. Facilities (e.g., schools, retail stores, stadiums, etc.) may provide emergency responders with building/structure layouts, allowing the users to be plotted accurately within a given building or structure. In other words, the emergency responder would be able to see which classroom, aisle, etc. a user is in and the best method of locating and extracting that user. This is extremely beneficial as it allows the responder to familiarize themselves with the facility prior to entering, which can be a matter of life and death.

In one embodiment, the GPS emergency application comprises an intermediate step that prevents toddlers from accessing or initiating an emergency response. The intermediate step may comprise a password, biometrics recognition (e.g., fingerprint, facial recognition, etc.), or any other preventative mechanism.

Further, there has not been an emergency software application in the prior art focused on providing an inaudible distress signal as well as a GPS location. The GPS emergency application herein gives victims and emergency responders a tool to control emergency situations with real-time data. Finally, the emergency GPS signal system provides an easy, convenient, and secretive (i.e., inaudible) way of notifying emergency responders of emergency or abusive situations and of the exact location of those situations.

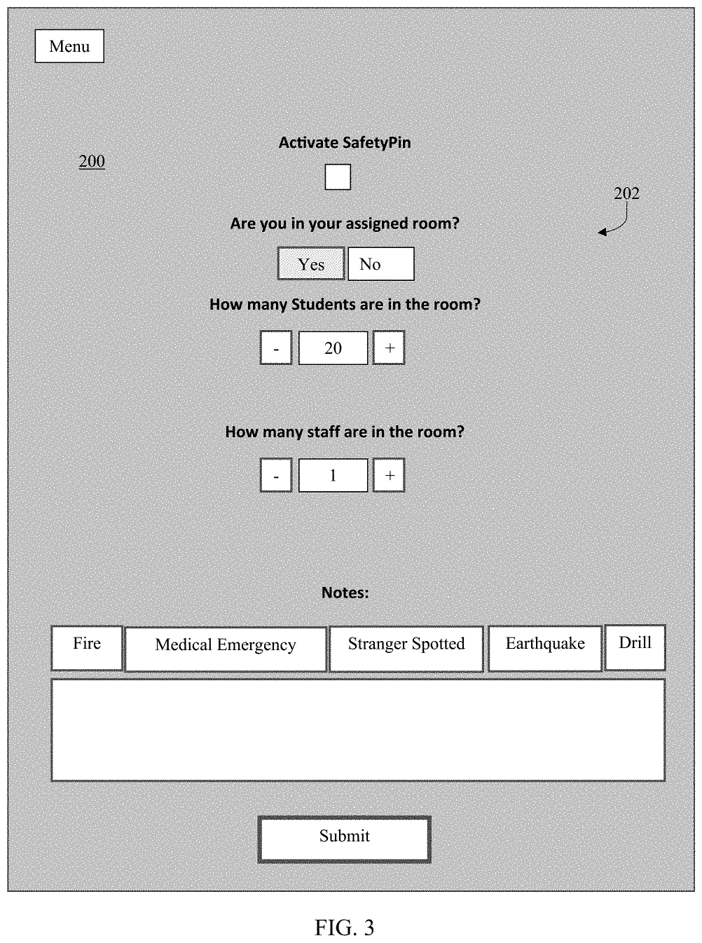

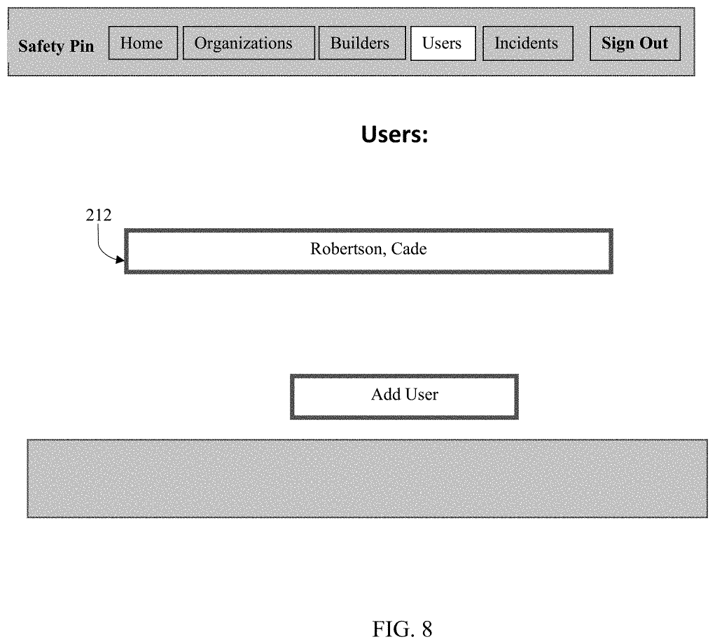

While GPS information is preferred and described herein, it is not required, and other methods of ascertaining location, as mentioned earlier herein, may be used. Additionally, a software application need not be downloaded or installed on a device—any internet-connected device that may access a website for submitting the emergency distress signal may be used. Using a school as a non-limiting example, and explained with reference to FIGS. 3-8, a teacher or administrator may access a webpage 200 comprising a user interface 202 for gathering information about the emergency. For example, the user interface 202 may have text boxes, radio buttons, drop-down menus, or other means of input allowing a user to input information. For example, the user interface 202 may request information such as whether the teacher is sending the information from their assigned room, the number of students in the room, the number of staff in the room, may suggest one or more pre-defined emergencies (e.g., Fire, Medical Emergency, Stranger Spotted, Earthquake, Drill, etc.), as well as a text input box for other information the submitter deems relevant.

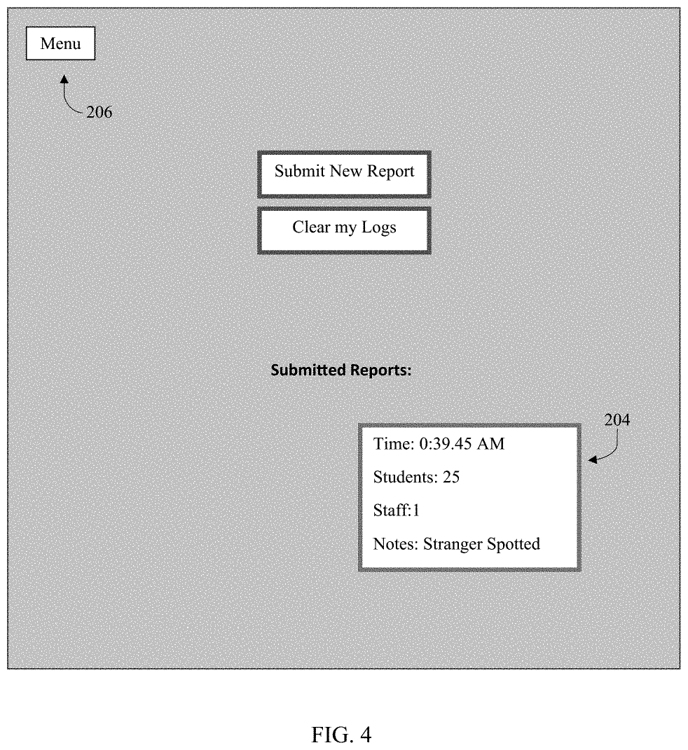

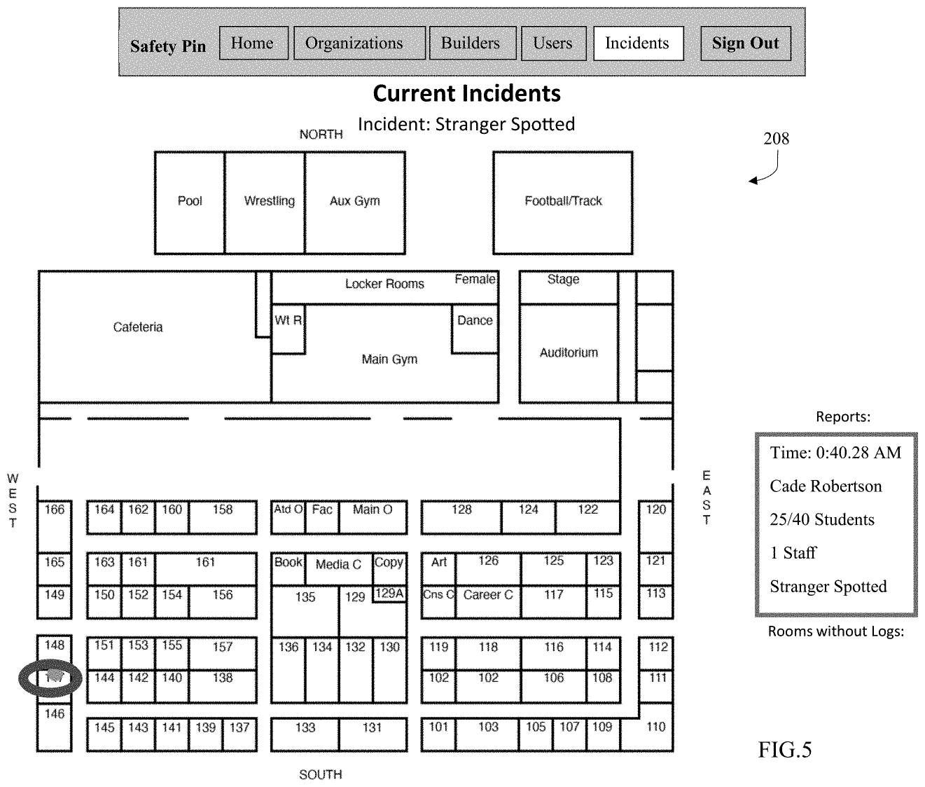

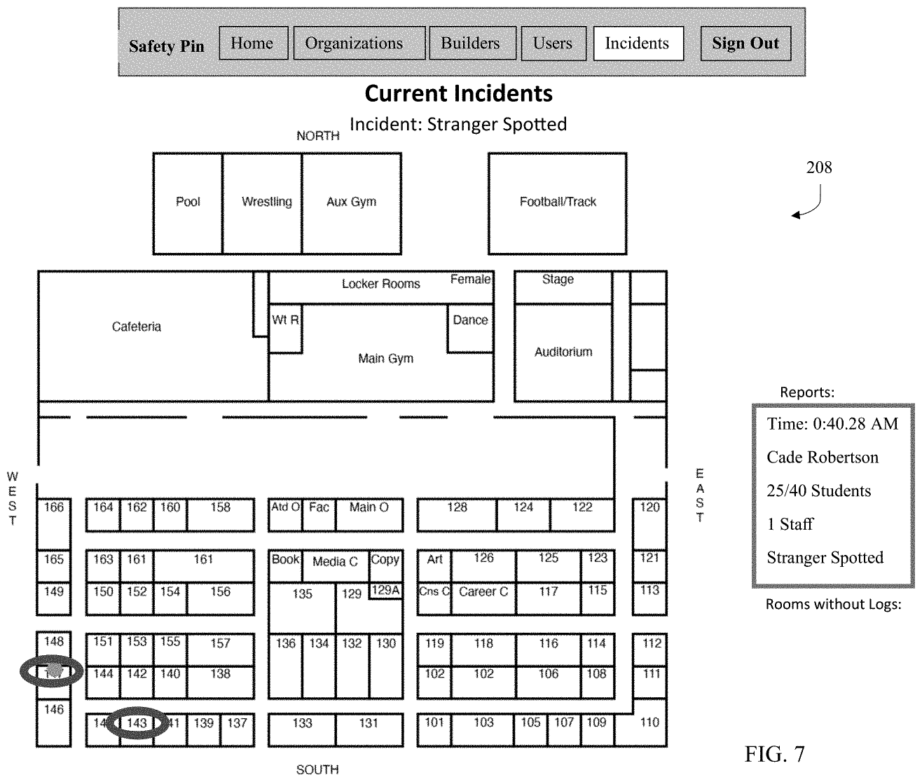

As shown in FIG. 4, a user (teacher, administrator, or other submitter) may view the reports 204 (distress signals) that have been submitted. This, and other information, may be accessible using a menu 206. Referring to FIG. 5, a geographic map and/or building layout 208 with preconfigured location information (e.g., highlighted or circled room) may be sent to emergency responders and other administrators (e.g., school and district administrators). In other words, if the teacher selected that they were in their classroom, the layout would be transmitted with the room circled or highlighted. This allows first responders to know the exact location of the incident. If additional teachers submit distress signals, the layout 208 would illustrate the location of each distress signal on the same layout 208 (see FIG. 7, discussed later herein). This may be relevant for determining the direction and current location of an intruder or locations of all possible victims. The layout 208 also allows first responders to determine the fastest entry and exit points, the inner location of the user, among other information. The ability for responders to know the exact location of victims within a structure, as well as have a safe way to communicate with victims, such as by using text chat, allows unprecedented response and safety in emergency situations.

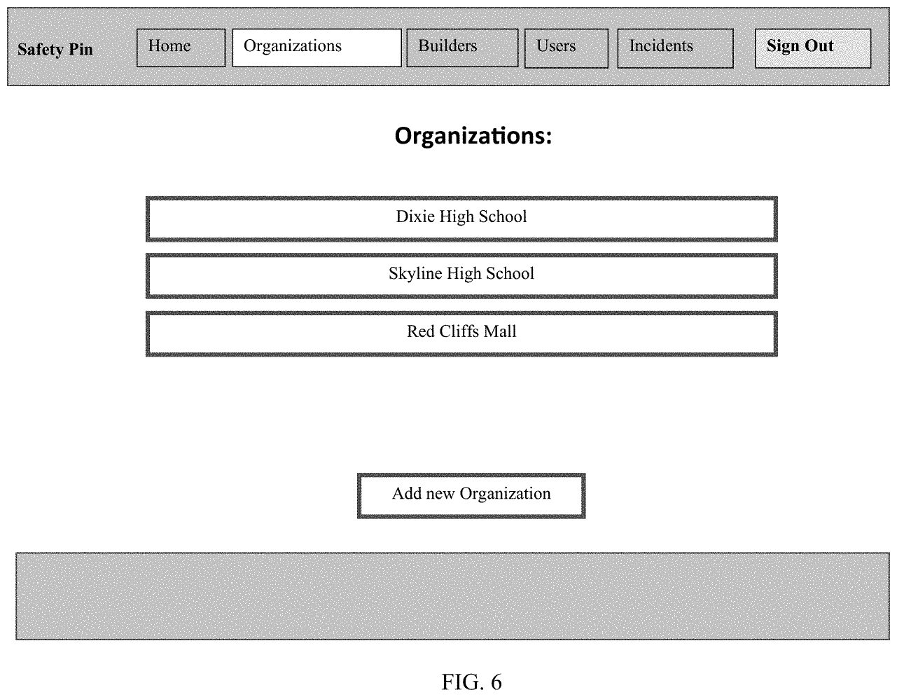

Referring to FIG. 6, an area dispatch provider may have access to a list 210 all organizations enrolled in the system, including schools, malls, theaters, office buildings, or other structures. In some embodiments, building information, such as layout 208, may also be viewed and/or inputted, allowing for accurate location data to be obtained and viewed. In the school example above, the school would be registered with the system and the layout 208 uploaded into the system (e.g., computer or server with memory and a processor, connected to the internet), which may be done by a user, an administrator, dispatch, or other user. Each teacher is then assigned, on the layout 208, to their corresponding classroom (i.e., pre-programmed coordinates), and is provided with a link or icon to access the distress signal system.

As an example, if Mr. Robertson was assigned to classroom 147, when he transmits an emergency distress signal, such as from his classroom computer, room 147 is highlighted on layout 208, as shown in FIG. 5. If Ms. Anderson is assigned to room 143 and she likewise submits an emergency distress signal (whether on her computer or smartphone), both rooms would be highlighted on the same layout 208, as shown in FIG. 7. In this scenario, GPS location is not required. However, if GPS information is available, such as if Ms. Anderson used a smartphone to transmit the distress signal, the system may use the GPS information transmitted by the smartphone to further ascertain/ensure the location of Ms. Anderson.

FIGS. 5-8 illustrate an administrative portal. As shown, the administrative portal may comprise maps/layouts, organizations, users, etc. For example, user information 212 may be viewed, modified, or added, by an administrator, which allows users, such as teachers, to have access to the emergency distress webpage 200, such as by assigning unique logins or links for each user. School administrators may change the classroom information for teachers when they change classrooms, may delete retired teachers and add new teachers, etc. Dispatch, responders, or other administrators may have access to other information as well, such as a record of reports/incidents, real-time status, or other relevant information, any of which may be accessible using a menu.

Accordingly, in one embodiment, a method of reporting and responding to an emergency situation comprises a user activating a distress signal via a website or smartphone application, the user optionally inputting information to be transmitted to responders with the distress signal, which may include the nature of the emergency, with the emergency distress signal including the location of the user via GPS or preconfigured information (e.g., classroom location, as discussed above); and, emergency responders receiving the distress signal, such as via push notifications, including the location, building layout, and any information supplied by the user. Optionally, the responders and the user may be connected via a text chat interface to discuss the emergency in real-time.

It will be appreciated that a system for reporting and responding to emergency situations comprises, in some embodiments, a user device (for reporting an emergency), a server for receiving and transmitting reports and other information, and a responding device (first responder device, such as computer, tablet, smartphone, or other device capable of displaying location information). The user device and the responding device may each comprise a software application for sending and receiving the emergency distress signal, location information, and ability for text chat (and optionally, call and video chat), or may each also be simply internet-connected and able to access such information through a hosted website.

As will be appreciated from the foregoing, the emergency GPS signal system allows a user to send a silent distress signal to first responders. This is very important whenever there is an intruder. Additionally, the emergency GPS signal system provides responders with GPS location information, predefined location information, and building layout information. This allows first responders to quickly and safely find the emergency, which may include helping victims or finding and securing intruders. Additionally, the emergency GPS signal system may comprise the ability for real-time chat between the user and the first responder, which can be critical in any emergency. Lastly, multiple emergency distress signals (e.g., reports) may be received by first responders, with each emergency plotted on a map and/or building layout, allowing first responders to quickly ascertain the location of each emergency and the people involved. This overcomes the problems in the art, particularly in allowing for text transmission of emergency situations as well as location information, including building layouts. In some embodiments, the building layouts correspond to geographic locations such that when a GPS signal is received, a processor may determine whether the geographic location corresponds to the GPS location of a building in the system. If the layout of the structure is in the system, it may be overlayed on the geographic map so that responders can see the individual's exact location within the structure at the geographic location.

In one embodiment, first responders may send a request using an internet-connected device for the location information for everyone inside of a given structure when an emergency is reported. Each smartphone in the structure may receive the request and transmit the location information back to the responder, where it is plotted on a map or structure layout in real-time. It will be appreciated that acquiring and sharing location data via a smartphone is known in the art and will not be described in detail here. However, a server or other processor may aggregate the received location information from multiple reports/devices and plot them on a single map in real-time, allowing a responder to see multiple transmitting locations on a single map or building layout, such as a school. In one embodiment, a user of a smartphone must affirmatively opt-in to sharing their location information with emergency services. A user may opt-in prior to receiving the emergency location request, such as via a web site, text messaging, etc., or may opt in at the time the request is received from first responders. For example, responders may send a signal to phones within a certain radius of a reported emergency requesting the location information. For individuals that had previously opted in, their phones would automatically send the response (the user may or may not be notified of the transmission). For individuals that had not yet opted in, they would receive a message, such as a text message, alerting them to an emergency and requesting authorization to collect their location information, which may be done on a case-by-case basis or an ongoing approval. With the location information gathered, emergency responders are much better prepared to handle the emergency.

Accordingly, as will be appreciated from the foregoing, users, victims, and emergency responders are able to communicate safely and reach the emergency in a faster, and safer, manner.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A method of locating and responding to an emergency distress signal, comprising:
a user transmitting an inaudible emergency distress signal via an internet-connected device, the emergency distress signal comprising location information and user-inputted information regarding an emergency.

2. The method of claim 1, wherein the location information is obtained using a GPS receiver of the user device.

3. The method of claim 1, wherein the location information is preprogrammed based upon the user or an expected location of the internet-connected device.

4. The method of claim 1, further comprising a processor to process the received emergency distress signals and to plot the location information, the processor then transmitting the location information to first responders.

5. The method of claim 4, wherein the location information is plotted on a geographical map.

6. The method of claim 4, wherein the location information is plotted on an internal layout of a structure.

7. The method of claim 4, further comprising a user chatting via text with the first responders in real-time.

8. A system of locating and responding to an emergency distress signal, comprising:
an internet-connected device having a user interface, the user interface comprising:
an input field for the number of potential victims,
one or more fields for inputting a description of the emergency, and
a submit button to transmit the inputted information to first responders;
a processor for processing the received emergency distress signals, the processor configured to plot the location of each emergency distress signal on a map or structure layout, the processor further configured to transmit the map or structure layout to a display viewable by the first responders; and
a communication server configured to transmit messages between the user and the first responders.

9. The system of claim 8, wherein the internet-connected device is a smartphone.

10. The system of claim 9, wherein the smartphone comprises a GPS receiver, the smartphone configured to transmit a GPS location, as determined by the GPS receiver, with the emergency distress signal.

11. The system of claim 8, wherein the internet-connected device is a computer.

12. The system of claim 11, wherein the location information is pre-programmed.

13. The system of claim 8, further comprising a log of previously submitted emergency distress signals configured to be viewed on the internet-connected device by the user.

14. The system of claim 8, further comprising an administrative portal, the administrative portal comprising one or more lists of:
a. participating organizations,
b. participating users,
c. structure layouts, and
d. incidents;
wherein the administrative portal is accessible to an emergency dispatcher and each list is modifiable by an administrator.
